(19) United States
(12) Patent Application Publication
(10) Pub. No.: US 2014/0083313 A1
(43) Pub. Date: Mar. 27, 2014

(54) METHOD AND DEVICE FOR OPERATING A MACHINE TOOL SUCH AS A PRESS WITH A LINEARLY MOVABLE STROKE ELEMENT

(71) Applicant: SCHULER PRESSEN GMBH, Goeppingen (DE)

(72) Inventors: DIETMAR SCHOELLHAMMER, Goeppingen (DE); Thomas Spiesshofer, Bermatingen (DE); Anton Lendler, Weingarten (DE)

(73) Assignee: SCHULER PRESSEN GMBH, Goeppingen (DE)

(21) Appl. No.: 14/037,380

(22) Filed: Sep. 26, 2013

(30) Foreign Application Priority Data
Sep. 27, 2012 (DE) 10 2012 109 150.1

(51) Int. Cl. B30B 15/26; B30B 15/14

(52) U.S. Cl. CPC B30B 15/26; B30B 15/148
USPC 100/35; 100/214; 100/48

(57) ABSTRACT

A method for operating a machine tool includes determining and providing/storing energy for machining a work piece as available energy by considering a first value of the energy to be applied of at least one element of the machine tool to store energy. Available energy provided in a section or in a partial section of a motion sequence of a stroke element determined for machining the work piece is gathered. Part of the available energy of the energy to be applied for machining the work piece from an energy potential provided/stored in the machine tool is used. A second value for an effective required energy is formed via at least one energy-storing element. A control/regulation of different energy transfers or contents of individual drive components is influenced in an accelerating or decelerating manner during a sequence of the stroke element or during a path of a stroke to compensate for asymmetric loads.

### CROSS REFERENCE TO PRIOR APPLICATIONS

Priority is claimed to German Patent Application No. DE 10 2012 109 150.1, filed Sep. 27, 2012. The entire disclosure of said application is incorporated by reference herein.

### FIELD

The present invention relates to a method and a device for operating a machine tool such as a press with a rotationally or translatorily driven and linearly movable stroke element, more specifically, for a press with a plunger acting by means of a tool on a work piece to be machined.

According to the present invention, the machine tool such as a press can be used for forming, compacting and packetizing, for cutting materials of any kind, and also as a transfer press or in press lines. The drive for the stroke element such as a plunger can also be implemented as a linear drive.

### BACKGROUND

Said machine tools such as presses substantially have a drive device connected with drive elements and comprise at least one motor or servomotor, a plunger performing a stroke and receiving at least one upper tool part, several tie rods or connecting rods engaging with the plunger for transmitting the drive for at least one stroke of the plunger. The plunger thereby holds an upper tool part, which corresponds to a bottom tool part for machining the work piece. The stroke of the plunger is frequently operated via or before an upper dead center to or via a bottom dead center, including for single strokes or a so-called reciprocating operation. A control and regulation device provides for an operation of the machine according to the input process data.

Presses were originally driven by an electric motor and an energy-saving flywheel. Energy-efficient drives by means of a servomotor have in the meantime increasingly prevailed.

EP 1 880 837 A2 describes a press unit with an energy management system which, on the one hand, has sufficient capacity for receiving additional energy and, on the other hand, sufficient energy at any point in time to bring a respective press cycle to its end. A servomotor drive is used, but the overall concept of this press is not yet sufficiently energy efficient.

As a whole, conventional presses with servomotors are operated successfully and in an energy-saving manner, but they do not necessarily present an increase in the output of the work pieces to be machined.

DE 10 2007 003 335 A1 also addresses the issue of facilitating the programming of drives for presses, which have one or several servomotors and a plunger, which are connected with a linkage. DE 10 2007 003 335 A1 describes a transmission behavior of the linkage which has a high dynamic stiffness in the vicinity of the bottom dead center of the plunger. The program already collects representations of the resulting movements of the plunger in order to intervene in a controlling manner.

DE 10 2007 024 024 A1 describes a drive device for a multi-plunger transfer press to implement both high pressing forces and variable plunger movements with at least one main drive and at least one secondary drive.

The relatively high level of effort required of the entire drive device to transfer the drive energy to all levels of the multi-plunger transfer press or to all single presses of the press line does not give any obvious incitement to look for possibilities of here implementing better energy efficiency.

This also applies to the plunger movement in a multipoint forming press as described in 10 2007 026 727 A1, in which, on the one hand, high pressure forces are implemented with the available torques of servomotors and, on the other hand, the drive effort is reduced by several mechanically synchronized pressure points.

After consideration of the examined solutions and of the applied rules, further approaches can thus be found for their differentiation with regard to the technical problem, which provide for a method and device for operating a machine tool, such as a press, with a linearly movable stroke element, which is improved in terms of energy efficiency and output optimization.

Solutions to generic machine tools such as presses are also described in US 2009/0007622 A1, EP 1 640 145 A1, EP 0 947 259 A2, DE 10 2008 038 264 A1, DE 10 2009 057 409 A1 and DE 102 31 031 A1.

EP 1 640 145 A1, for example, describes a system that has a flywheel which is adapted to be switched on and off, wherein the flywheel possesses a separate small drive motor and the energy stored in the flywheel is engaged in times of great energy requirements during forming.

Two drives are thus provided with the objective of operating a highly dynamic, low-inertia system by way of a servomotor in such a manner that rotation speed and speed are modifiable in an operation mode in which the flywheel is switched off. The performance of the servomotor is thereby limited in order to engage a separate flywheel when a high working capacity is required during the forming process.

DE 10 2009 057 409 A1 describes a method and a structural implementation of a press which is equipped with a servomotor. This solution thereby refers to the control and regulation of the servomotor, but does not explicitly refer to an energetic distribution of the stored energy to components of the press or of the drive train. It refers to the operation of a servo press, the components of which are diverse and are thus anyway provided with inertias and stored energies. Characteristics of an energy-related use are not disclosed.

DE102 31 031 A1 describes a system which is driven by two drives, wherein a dynamic drive (servo drive) is coupled directly with the press and a separate flywheel is engageable with a second drive. This application is also characterized by the two necessary drives.

US 2009/0007622 A1 lastly describes a method to operate a mechanical press in which at least one electrical drive motor, a mechanical element as well as a plunger are used via a control/regulation device for executing a cycle for a part to be pressed and for one or more parts not to be pressed in the cycle, wherein a control output is used for regulating the drive in such a manner that a speed of the drive motor during said cycle is variable.

According thereto, a person skilled in the art can provide a method for operating a mechanical press, which is structured as follows:
At least one electric drive motor with a connectable flywheel;
A control/regulation device for said drive motor;
A mechanical element, such as a plunger for operating the press for the execution of a cycle for a part to be pressed and for one or more parts not to be pressed in said cycle;
Providing a control output for said drive control in such a manner that a speed of the drive motor is variable during the cycle;
The plunger connected with an eccentric shaft as a drive shaft, wherein the eccentric shaft driven by a servomotor or torque motor executes a working phase at a working speed and a transport phase at a transport speed;
The drive comprising the servomotor or torque motor with a moment of inertia that is modifiable by way of the flywheel, which is engageable in the working phase and disengageable in the transport phase;
Energy-transforming means (hydraulic elements, coupling) of an energy transfer for converting kinetic energy into hydraulic energy during the operation of the plunger, wherein the kinetic forming energy is absorbed and transformed into hydraulic energy and vice versa; and
In a case without operation of the flywheel, the movement of the plunger is supported more specifically in the reversal points at the top dead center and at the bottom dead center by the association of a pneumatic energy storage implemented as a piston/cylinder unit with the press, wherein its piston rod is attached to the plunger via a releasable clutch.

An analytical evaluation of this compiled prior art with regard to energy efficiency and production optimization of generic machine tools, such as presses, regularly equipped with two different types of drives shows:
1. Machine tools such as presses, which have an energy storage such as a flywheel, obtain the energy required for forming the workpiece, for example, from the flywheel. In these presses, no energy-efficient change of the direction of movement can occur between two strokes during the production process. In these presses, a change of the rotational speed within a stroke is additionally only possible to a very limited extent.
2. Machine tools such as presses, the drives of which are designed so big that the energy required, for example, for forming is taken directly from the press drive, can only implement strong changes of the rotational speeds because the big but energy-intensive drive design makes it possible.
3. Drives with a hybrid form of previously characterized embodiments, i.e., in which a big drive contributes a big proportion of the forming energy, while using the kinetic energy only partially for forming, do not provide a cyclic reversal of the direction of movement of the rotary drives between two press strokes. In cases where a part of the forming energy is obtained from the kinetic energy of the machine, this leads to a slowdown negatively affecting the output, which is influenced by the forces generated in the forming process and is not taken into account in the movement specifications of the press.

Another field for researching energy-optimized solutions is opened by the research on developing the so-called “freedom of motion”. DE 10 2009 050 390 A1 thereby describes that smaller plunger strokes lead to an optimized freedom of motion instead of the previously generous freedom of motion of the press, to a reduced acceleration and speed of the plunger, but to an increase of the output of parts and to smaller paths being made possible through dynamic plunger strokes and transfer movements.

### SUMMARY

An aspect of the present invention is to provide a new “energy-saving press” which operates with a servomotor, and to constantly supply a minimal or a minimized energy requirement during the cycle time for which even the natural frequency of the machine must be adjusted to the target motion, in order to minimize the need for additional drive power.

So far, it has appeared that dynamic changes are indeed also regenerative, i.e., are usable regeneratively or recuperatively, but always with the disadvantage that such solutions are energetically reduced by the loss of energy efficiencies.

An aspect of the present invention is further to provide a method and a device with a minimal or minimized energy requirement as well as an operation of a machine tool such as a press with a linearly movable stroke element that increases the output, such as a press, for example, with a plunger acting with a tool on a work piece to be machined, wherein:
a modification of the direction of movement of the stroke element such as the plunger during the working process between the (two) strokes and a modification of the speed within a stroke must occur to the required extent without an energy-intensive drive power, while taking into account the movement specifications of the press,
the natural frequency of the machine can be determined through the design of an inertia, a mass and, if necessary, joint kinematics and influenced with elements for targeted energy transfers,
the conditions of impact velocity and breakaway velocity as well as the conditions of the problematic geometry also apply for defining the natural frequency of the machine, and
the movement of the stroke element (such as the plunger of a press) is adjusted to the process conditions so that both the required energy to be applied is optimized and the “freedom of motion” of said stroke element is provided.

In an embodiment, the present invention provides a method for operating a machine tool. The machine tool comprises a stroke element configured to be linearly moveable, and a drive configured to drive the stroke element. The stroke element is configured to be operated with at least one stroke via or before a top dead center to or via a bottom dead center for machining a work piece. The method includes steps for a targeted energy transfer which includes determining and providing/storing an energy for machining the work piece as an available energy by taking into account a first value of the energy to be applied of at least one element of the machine tool configured to store energy selected from a translationally or rotationally moved mass of the drive, a liftable/lowerable machine element, a pre-tensionable element, and an electrical energy storage device. The available energy provided in at least one section or in a first partial section of a motion sequence of the stroke element determined for machining the work piece in a cycle time, in a machining time, or in an opened time in the operation of the machine tool is gathered. At least a part of the available energy of the energy to be applied for machining the work piece from an energy potential provided/stored in the machine tool is used, and a second value for an effective required energy is formed via at least one energy-storing element selected from the translationally or rotationally moved mass of the drive, the liftable/lowerable machine element, the pre-tensionable element, and the electrical energy storage device. A control and a regulation of different energy transfers or different energy contents of individual drive components is influenced in an accelerating or in a decelerating manner during a chronological sequence of the stroke element or during a path of the at least one stroke so as to compensate for asymmetric loads resulting from an asymmetric force distribution in the machining.

### BRIEF DESCRIPTION OF THE DRAWINGS

The present invention is described in greater detail below on the basis of embodiments and of the drawings in which:

FIG. 1 schematically shows the principle of the movement patterns of the present invention, namely, a) shows the linear movement pattern of the plunger, and b) shows the rotational movement pattern of the drive;

FIG. 2 shows a virtual diagram of the model of natural frequency underlying the present invention;

FIG. 3 graphically shows the implementation principle of the method of the present invention with the symbols or dimensions of the relations according to the present invention; and

FIG. 4 shows a functional diagram of a device for implementing the method of the present invention.

### DETAILED DESCRIPTION

The inventive concept is characterized in that in the machine tool, such as a press:
the energy requirement is minimal if it is supplied minimally and continuously during the cycle time; and
the measures for reducing the energy requirements, such as providing the forming energy without drive power and/or operation close to the natural frequency to be adapted to the kinematic conditions, are implemented while taking into account the freedom of motion.

In an embodiment of the present invention, a unique type of drive aggregate is, for example, generally used to operate a servo press. If necessary, the drive can use several motors at high power, however, this must be subordinate to the single drive aggregate in accordance with the present invention. Any operative power required for operation of the system is supplied by this one drive aggregate.

As compared to this characteristic according to the present invention, it can be observed that in the machine tools, such as conventional presses examined in the introduction, the output of the motors or of a single motor of the drive is frequently transmitted by way of a mechanical wheel and lever gear to usually two or four connecting rods and divided, and transferred, for example, to the stroke element as the plunger and an attached upper tool part.

Control outputs for drive regulation merely serve to vary the speed of the drive motor during the working cycle.

With the drive aggregate according to the present invention, however, the gear train and thus the mechanical synchronization are to be dispensed with, even if the drive is implemented by several motors; instead they are to be electronically controlled or synchronized, but not only for regulating the speed.

The approach according to the present invention, which already stands out from the prior art, is thus put into practice, because the same principle is applied several times in the single drive aggregate by means of an electronically synchronized control.

This synchronization then not only impacts the operational parameters of the motors from the drive aggregate, but also on the control and regulation of the various energy transfers or energy contents of the individual drive components of the drive aggregate.

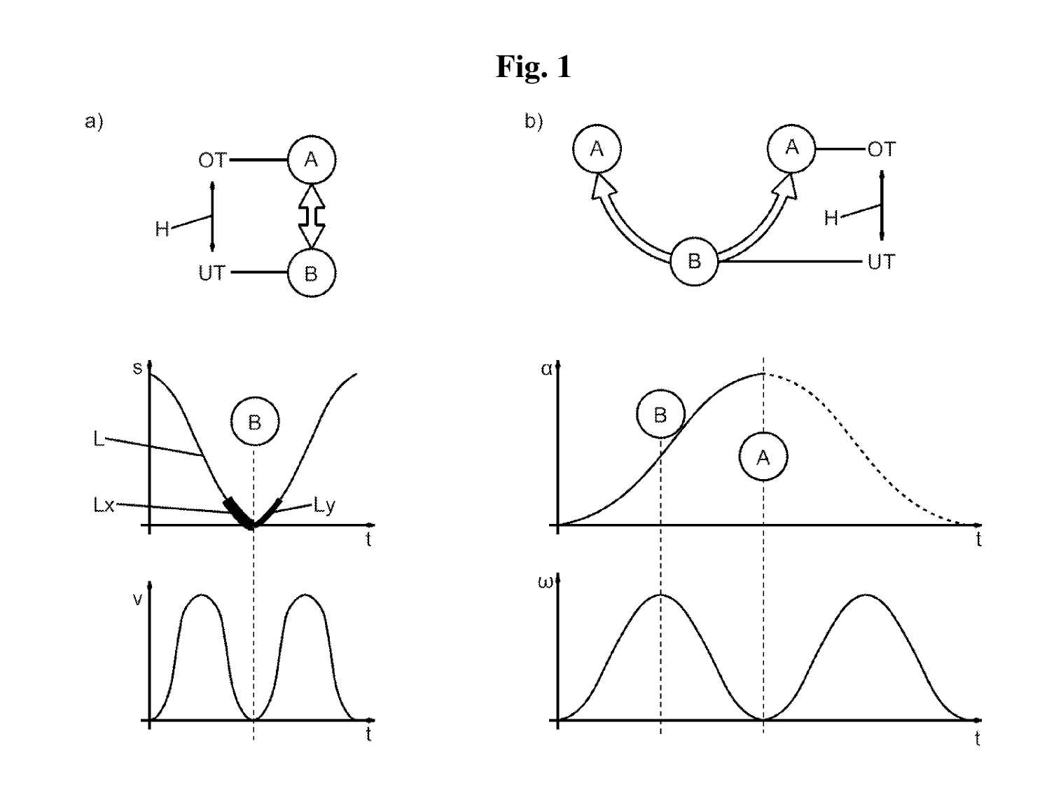

These active outputs are substantially designed for machining, such as forming the work piece, as well as to compensate for the friction and efficiency losses, the principle of which is schematically shown with reference to FIGS. 1-4. The system according to the present invention is thus supplied with energy by way of the single drive aggregate and energy is dissipated in the form of heat and forming energy.

This inventive idea further has an impact in that, within the closed system, the components used are matched with regard to their geometrical design and mass inertia and thus to their energy-saving property in such a way that targeted energy transfers between the components ultimately result in an advantageous overall effect for the operation of the press. This has an impact, for example, on the correct forming speed, which means that the forming speed can be influenced, for example, without modifying the rotational speed of a servomotor. The operational parameters of the press are thus influenced without any action from outside and thus without any further energy supply or discharge and therefore without further energy consumption.

Therefore:
either the installed motor output is additionally available in order to influence the forming process, or
the press can be adjusted with a smaller motor output to the respective work piece to be machined.

It is thus possible to react, without mechanical couplings such as a wheel and lever gear, to asymmetric stresses resulting from an asymmetric force distribution from a machining process such as a forming process, not only by a corresponding control and regulation of the drive motors, but also by concretely influencing energy transfers desired in accordance with the present invention.

This functionally advantageous effect is surprisingly easy to obtain, namely, without a mechanical synchronization, merely by the electronic synchronization between several motors in the drive aggregate.

The present invention discloses possibilities for influencing the different requirements of different work pieces and materials to be machined.

Energy can, for example, be temporarily stored within the closed machine system in a third means, in order, for example, to reduce the forming speed, for example, by moving the plunger of a press against a spring, the spring thereby giving off energy to the then tensioned spring and the spring then supplying the energy back to the system during the upward movement of the plunger. No energy exchange with the outside thereby occurs.

Other physical principles can, however, also be resorted to in order to temporarily store energy, such as, for example, changeable inertias in a flywheel, wherein the flywheel is then integrated as a component in the drive train, i.e., in the drive aggregate and is not to be attached to a separate drive.

In the present invention, the term energy has the following meanings, which are explained as follows for a better understanding of the present invention:
Required energy=energy to be expended=effective energy: This is the energy, which is required for machining such as forming a work piece and must be available as minimal energy in the machine system, otherwise the workpiece is not formed and the operation of the machine cannot be maintained.
Provided energy: This is the energy that corresponds at least to the required energy, but that is much greater as a rule, in order to provide a stable operating process of the machine.
Stored/storable energies: These are the differently dimensioned energies available within the closed machine system which act differently in absolute terms as well as in terms of their amount.
Energy transfers: These are the transfers of energies which are transferable within the completed machine system from several available energy sources. By influencing the energy distribution of different energy sources, an effect that is advantageous for the operation of the machine such as the press is achieved according to the present invention. The position energy of the stroke element such as the plunger of a press at the upper dead center can, for example, be divided into kinetic energy of the plunger and rotational energy of the drive. The greater the inertia of the rotational part of the drive, the smaller the downward speed of the plunger. Alternatively, energy transfers to other mechanical or electrical storage means are conceivable.
Energy states: These are the energy amounts collected and stored in the respective energy stores.

In an embodiment of the present invention, the method for operating the machine tool, more specifically, the press with at least one linearly moveable stroke element, such as a plunger driven by a single drive aggregate, for machining a work piece with at least one stroke via or before a top dead center to or via a bottom dead center, is operated in such a manner that in a sequence of steps or selection of steps, i.e., a chronological sequence or offset sequence, in the sense of a sequence of steps or parallelly offset steps:
a) The amount of the energy required for machining the work piece is determined and provided as energy in a first step by taking into account a first value of at least one energy storing element of the machine tool, such as:
   a translatorily or rotationally moved mass of a drive; or
   a liftable/lowerable machine element such as a stroke element; or
   a pre-tensionable element, such as a spring or a piston/cylinder unit; or
   an electrical energy store, such as an electrical network or accumulator;
b) In a second step, the energy thus provided is extracted in at least one section or in a first partial section of a motion sequence of the stroke element determined for machining the work piece in a cycle time or machining time or an open time in the operation of the machine tool; and
c) In a third step, the energy to be expended for machining the work piece is used from the energy potential stored and provided in the machine tool according to the above feature (a) and by forming a second value for an effective energy by means of at least one energy-saving element of the machine tool, such as:
   the translatorily or rotationally moved mass of the drive; or
   the liftable/lowerable machine element such as the stroke element; or
   the pre-tensionable element, such as the spring or the piston/cylinder unit; or
   the electrical energy store,
a control and regulation of the different energy transfers or energy contents of the individual drive components is influenced in an accelerating or decelerating manner during the chronological sequence of the stroke element (2) or during the path of the stroke (H) in such a manner that also asymmetric loads, resulting from an asymmetric force distribution in the machining process such as forming process, become compensable.

Independently subordinate to the principle of the present invention:
inertias or moments of inertia of at least one of the translatorily or rotationally moved masses of the drive or of at least one liftable machine element, such as the stroke element, are modified in order to influence the chronological sequence of the stroke element or the path of the stroke; or
the stored/storable energy from the pre-tensionable element, such as the spring or piston/cylinder unit, is modified in order to influence the chronological sequence of the stroke element or the path of the stroke, or
the stored/storable electrical energy of the electrical energy store is modified by designing an electric motor or an electric generator in order to influence the chronological sequence of the stroke element or the path of the stroke.

In an embodiment of the present invention,
a) the direction of motion of the rotary drive executing a full stroke can be changed after each one stroke via or before the top dead center to or via the bottom dead center or vice versa,
b) a standstill of the rotary drive can be initiated in a first end position of the linearly moved stroke element in the upper dead center in such a manner that said first end position corresponds to the standstill of the rotary drive,
c) a reversal of the movement of the linearly moved stroke element can be initiated in a second end position in the bottom dead center by way for example of joint kinematics, by partly use of the stored rotational energy the energy, whereby
d) for an effective energy requirement of the drive for machining the work piece, this energy takes into account at least one energy among the categories comprising a frictional energy, a forming energy, an energy for efficiency losses, an energy for accelerated or decelerated masses or an energy for compensating for a weight of the stroke element, i.e., can also be supplemented by at least one of the categories.

In an embodiment of the present invention,
a) the direction of motion of the rotary drive executing a full stroke can be maintained after each one stroke via or before the top dead center to or via the bottom dead center or vice versa,
b) a modification of the rotary drive can be initiated in a first end position of the linearly moved stroke element in the upper dead center in such a manner that the first end position corresponds to the standstill of the rotary drive,
c) a reversal of the movement of the linearly moved stroke element can be initiated in an end position in the bottom dead center by way, for example, of joint kinematics, by partial use of the stored rotational energy the energy, whereby
d) for an effective energy requirement of the drive for machining the work piece, this energy takes into account at least one energy among the categories comprising a frictional energy, a forming energy, an energy for efficiency losses, an energy for accelerated or decelerated masses or an energy for compensating for a weight of the stroke element, i.e., can also be supplemented by at least one of the categories.

In an embodiment of the present invention, under reference to the aforementioned,
a) the energy is determined, taking into account at least one of the categories comprising a natural frequency of the machine tool, an inertia of the rotary drive, a mass of the stroke element or of the joint kinematics and induced for a targeted energy transfer by way of at least one means, such as the spring, and
b) a motion sequence, such as the chronological sequence of the stroke element or the path of the stroke, is defined by taking into account the natural frequency according to at least one of the conditions of an impact velocity, a lift-off speed or of a problematic geometry.

In an embodiment of the present invention, the method can, for example, be expandable by determining the effective energy for the drive, taking into account at least one of the categories comprising:
a) the frictional energy resulting from a height of the stroke and from the joint kinematics,
b) the forming energy resulting from the operations of the tool,
c) the energy of energy efficiency losses comprising the areas of dynamic changes of the drive power or the natural frequency.

In an embodiment of a use of the method according to the present invention:
a) energy transfers from a positional energy of the stroke element to a divided kinetic energy of the stroke element and rotational energy of the drive within the closed system of the machine tool are matched to one another in accordance with the sequence of steps or selection of steps from the required energy to the formation of the effective energy by means of at least one of the energy storing elements of the machine tool or by means of designing a component or several components of at least one of the energy storing elements, in such a way that at least one movement of the stroke element supporting the respective states in the machining process, influenced by the chronological sequence of the stroke element or by the path of the stroke, is initiated in the machine tool such as the press, wherein
b) first data from at least one of the conditions:
   of stresses of the tool,
   for distances to be observed in an operation mode for coordinating motion processes as well as the freedom of motion for workpieces to be machined,
   of a high output of the work pieces to be machined,
   of an energy consumption, or
   of the chronological sequence of the stroke element or of the path of the stroke

is recorded,
c) the data then being input or applied either to influence the potential energy of a initial position of an involved component, such as a stroke element or plunger or to modify inertias of an involved, energy-storing component moved rotationally or translatorily, and the velocity curve of the involved component being controlled or regulated by way of the measured energy states in the machine tool, such as the press,
d) so that the performance data of the machine tool such as a press is optimized with regard to:
   stresses of the tool,
   distances to be observed in an operation mode for coordinating motion processes as well as the freedom of motion for work pieces to be machined,
   an output of the work pieces to be machined,
   the energy consumption, or
   the chronological sequence of the stroke element or the path of the stroke.

In an embodiment of the method of the present invention, the data for drive powers for an optimized chronological sequence of the stroke element or path of the stroke is formed by taking into account at least frictional forces or at least one energy for machining the work piece or both categories, wherein that data of frictional forces or of an energy for machining the work piece is determined based either on data from an entire section of a motion sequence of the component involved (stroke element such as a plunger) or from a partial section.

In an embodiment of the present invention, the data from dynamic changes of the involved component, such as the stroke element, plunger, can be recorded and input or applied for an overlay of the optimized progress of the stroke element or of the path of the stroke.

In an embodiment of the present invention, the joint kinematics (such as the joint transmissions) can, for example, be operated, depending on the rotational speed of the rotary drive, for the energy-optimized movement of the involved component, such as the stroke element, plunger for machining the work piece, so that an ideal rotational speed of the optimized movement of a machining process and not a constant rotational speed is reproduced.

In an embodiment of the present invention, the data for the movement of the involved component, such as a stroke element, plunger to be optimized, can, for example, be defined by way of an analysis tool of a control and regulation device and provided as data for a target speed for moving the respectively involved component in order to operate the machine tool such as the press.

In an embodiment of the present invention, the method can, for example, be implementable by using a program for the control and regulation device, which comprises at least one of the following program steps:
Recording, processing, inputting data for:
   the direction of movement of the rotary drive,
   the respective end position of the linearly moved stroke element such as the plunger in the top dead center or bottom dead center,
   the standstill of the rotary drive in the top dead center and correspondence of the end position with the standstill of the rotary drive,
   the reversal of the movement of the linearly moved stroke element such as the plunger in an end position in the bottom dead center via the joint kinematics by means of the rotational energy stored in it;
Recording, processing, inputting data for:
   the occurring energy transfers from the required energy to the formation of the effective energy for initiating a course of the stroke element or path of the stroke supporting or optimizing the respective states in the machining process,
   stresses of the tool,
   distances to be observed in an operation mode for coordinating motion processes (freedom of motion) for work pieces to be machined,
   a high output of the work pieces to be machined;
Recording, processing, inputting data to influence the potential energy of an initial position of an involved component (stroke element such as a plunger) or to modify the inertias of an energy storing component (stroke element such as a plunger or rotary elements, such as the drive) and the velocity curve of the involved component by way of the recorded energy states in the machine tool such as the press;
Recording, processing, inputting/applying data for drive powers for the optimized course of the stroke element or the path of the stroke, taking into account frictional forces and an energy (such as a forming energy) for machining (such as forming) the parts such as work pieces, which is determined based on data of a whole section or a partial section of a motion sequence of the involved component (stroke element such as plunger);
Recording, processing, inputting data of dynamic changes of the involved component (stroke element such as a plunger or rotary elements, such as a drive) for an overlay of the optimized course of the stroke element or of the path of the stroke;
Recording, processing, inputting data for the joint kinematics (joint transmissions) to be controlled as a function of a rotational speed of the rotary drive for an optimized course of the stroke element or path of the stroke; or
Recording, processing, inputting data for the optimized course of the stroke element or path of the stroke by way of the analysis tool of the control and regulation device and presetting that data for the operation of the machine tool such as the press.

In an embodiment of the present invention, the method disclosed is, for example, implemented by a device for a machine tool such as a press with at least one linearly movable stroke element such as a plunger as a first energy source, the stroke element such as a plunger:
being connected to a translational or rotary drive as a second energy source, and
being operatable in strokes via or before a top dead center to or via a bottom dead center,

wherein,
a) the direction of motion of the rotary drive after each stroke via or before a top dead center to or via a bottom dead center (or vice versa) is changeable or maintainable, and
b) in an end position of the linearly moveable stroke element such as a plunger in the top dead center, a standstill of the rotary drive occurs, the end position corresponding to the standstill of the rotary drive, and
c) a reversal of the movement of the linearly movable stroke element such as a plunger is inducible in an end position in the bottom dead center by way of joint kinematics by means of the energy stored in the second energy source.

In an embodiment of the present invention, a control and regulation device can, for example, be used, which initiates an optimized course of the stroke element or path of the stroke (H) of the machine tool such as the press supporting the respective conditions in the machining process, and with which:
Data from at least one of the conditions:
   of stresses of the tool,
   for distances to be observed in an operation mode for coordinating motion processes (freedom of motion) for work pieces to be machined, or
   of a high output of the work pieces (2.2) to be machined,
is first recordable,

the data being then adapted to be input either to influence the potential energy of an initial position of an involved component of the first energy source (stroke element such as a plunger) or to modify inertias or moments of inertia of an involved component, of a rotary element such as the motor or of a spring element, and the velocity curve of the involved component (stroke element such as the plunger) is adjustable by way of the recorded energy states in the machine tool such as the press,
so that the performance data of the machine tool such as the press is optimizable with regard to:
   stresses of the tool,
   distances to be observed in an operation mode for coordinating motion processes (freedom of motion) for the work pieces to be machined,
   an output of the work pieces to be machined,
   the energy consumption.

In an embodiment of the present invention, the device can, for example, have both conventional assemblies, such as:
a) the single drive, comprising at least a motor, an eccentric gear, a rotary drive such as a pinion gear or a translational drive such as a linear drive,
b) joint kinematics, comprising at least connecting rods, guide elements, traction/pressure elements or tie rods,
c) energy storing means, such as at least:
   a first energy source, comprising the stroke element and/or a stroke element/plunger weight compensation device, and
   a second energy source, comprising the translational or rotary drive (3) and a flywheel,

as well as new means of the control and regulation device for recording, processing or outputting a respective amount:
of an energy required for machining the work piece,
of a first value of at least one energy-storing element of the machine tool as an available energy in at least one section or first partial section of a motion sequence of the stroke element, determined for machining the work piece, and
of a second value as an energy that is effective in a cycle time or machining time or an opened time in the operation of the machine tool.

In an embodiment of the present invention, the device can, for example, be completed by using at least one energy storing element, whose inertia or moment of inertia is modifiable, wherein the energy storing element can be formed for modifiable inertias or moments of inertia:
by use of the flywheel or of a flywheel with a modifiable effective diameter, or
by use of a flywheel configured as a hollow body, the hollow body being adapted to be filled with or emptied of liquid media or bulk materials for modifiable inertias or moments of inertia, or
by use of flyweights influenced by the rotational speed, or
by use of a body that is loadable by the stroke element such as the plunger and modifiable inversely to a speed of the stroke element such as the plunger.

In an embodiment of the present invention, the device can, for example, allow for cyclically controllable/regulatable or tool-dependent presets for each press stroke through variable inertias or moments of inertia of the designated components.

To the person skilled in the art, the present invention discloses avoiding the disadvantages identified in the introduction, for example, in a device for sheet metal machining, which comprises a tool and a press in which the tool is installed, wherein the press has a linearly moveable press plunger, and that the rotational and linear movements within the movement cycle can come to a standstill twice at the same time and the kinetic energy is stored partially in adapted units (springs, electrical energy through regenerative braking) and is otherwise available as a potential energy of the linearly moved masses.

The amount of this potential energy can be configured so that it covers a substantial part of the energy required for forming and surprisingly represents more than 50%.

At the end of the forming section, the linear movement of the press plunger tends toward zero, while the rotational energy of the press drive has an amount greater than zero, wherein its direction of movement does not change during forming.

However, according to the prior art of press lines having an energy store such as a flywheel, from which the energy for forming is obtained, no changes to the direction of movement are possible between two strokes during the production process. Also, in these presses, a modification of the rotational speed within a stroke is only possible to a very limited extent.

In addition, the present invention avoids the disadvantages of presses with drives that are so big that the energy required for forming is obtained directly from the press drive, and that the great changes of the rotational speeds can only be made possible by high power outputs.

The disadvantages of drives in which a hybrid form of both versions is given, namely in which a big drive contributes a big proportion of the forming energy, whereas the kinetic energy is partially and/or marginally used for forming, are also avoided. Even though, in these presses, the person skilled in the art finds a cyclic reversal of the direction of movement of the rotary drives between two press strokes, in cases in which a part of the forming energy is obtained from the kinetic energy of the system, this leads to a slowdown of the strokes. Since this slowdown is necessarily affected by the forces generated during the forming process, it is not taken into account in the movement specifications of the press in the prior art.

In order to graphically illustrate the initial situation of the problem solved by the present invention, the principle of the linear movement of the plunger and the rotary movement of the drive will first be shown as a schematic principle of the movement patterns in the virtual example of a press with a plunger in accordance with FIG. 1, namely in detail a) as a linear movement pattern of a stroke element such as a plunger not shown here and in detail b) as a rotary movement pattern of a drive not shown here.

The following symbols operationally stand for:

A=start and end of the movement
in rotationally moved units such as the drive: Standstill (detail b))
in linearly moved units such as the plunger: Standstill (detail a)).
Forms of energy: Potential energy of the linear units (press plunger, upper tool), possibly additional energies directed downward from units that can store energy (for example, springs, or the like.).

B=End of the forming movement
in rotationally moved units: Standstill (detail b))
in linearly moved units (detail a):

The potential energy from position A is partly converted into forming energy, possibly partially stored in other units (for example, spring forces, electrical energy via regenerative braking) and is otherwise converted into rotational energy of the press drive. This rotational energy is capable of completely or partially transferring the linearly moved mass of the stroke element, such as the plunger, to the initial height at position A via joint kinematics. Stored energies (for example, spring forces, electrical energy, see above) thereby provide support. The electric drive supports the return by compensating for the power losses and forming output. This aid may occur at any time of the overall movement and is either constant or controlled in such a way that a more favorable movement pattern is formed.

Forms of energy: No further usable potential energy, kinetic energy in the rotationally moved units and additional energies directed upwards from units that can store energy (for example, springs, or the like).

In FIG. 1 a top dead center OT and a bottom dead center UT are further indicated as a limitation of a stroke H of the stroke element such as the plunger not shown. In the coordinate system of the upper curve according to detail a), t=the time axis and s=the distance axis and a section L with a first partial section Lx and a second partial section Ly of the linear motion sequence of the stroke element, such as the plunger, are shown, wherein B=UT designates the end of the forming movement relevant to the present invention in a forming time=Lx+Ly. The bottom curve characterizes the entire sequence of the linear motion pattern, taking into account an axis V=speed.

In the coordinate system of the top curve and of the bottom curve according to detail b), a and w respectively represent the speeds of the rotational motion pattern of the drive (not shown) along the time axis t and are compared to the linear motion sequence, in which the positions A=start and end of the movement and B=end of the forming movement are marked.

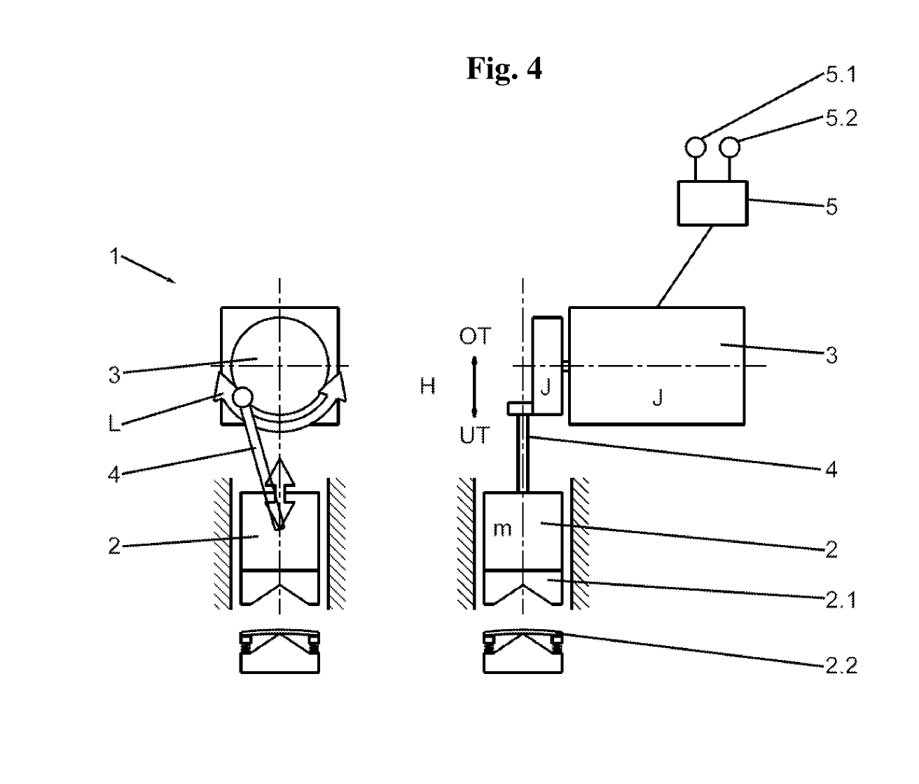

The method according to the present invention for operating a machine tool 1, more specifically a press with at least one linearly moveable stroke element 2 such as a plunger of the press 1, schematically shown as a device in FIG. 4, the stroke element 2 being driven by a rotary drive 3 via joint kinematics 4 for machining a work piece 2.2 and being operated with at least one stroke H via or before a top dead center OT to or via a bottom dead center UT, is shown to the person skilled in the art in a comprehensible manner with regard to the essential features, which provide that:
a) the direction of motion of the rotary drive executing a full stroke H can be changed after each one stroke via or before the top dead center OT to or via the bottom dead center UT or vice versa, and
b) a standstill of the rotary drive 3 can be initiated in a first end position A of the linearly moved stroke element in the upper dead center OT in such a manner that said first end position A corresponds to the standstill of the rotary drive 3,

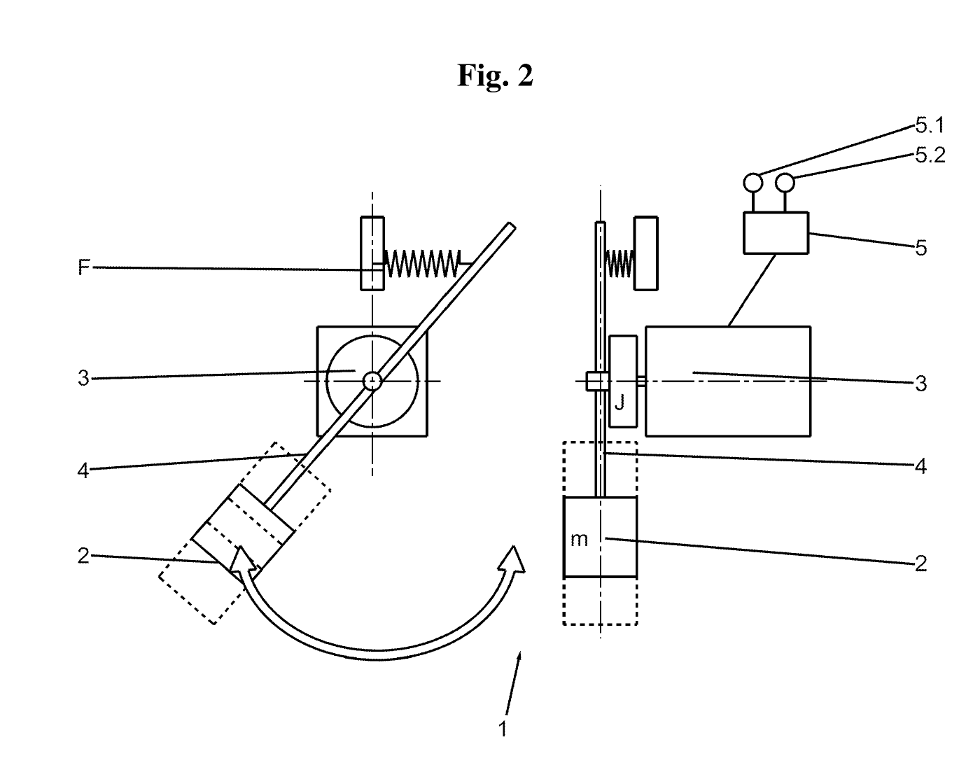

In order to be able to comply with the other essential features of the inventive idea with regard to the energy required for the object of the present invention, FIG. 2 first illustrates the inventive approach with a virtual diagram of the model of the non-designated natural frequency underlying the present invention. Here, the so-called natural frequency is determined for the energy transfer based on the mass m of the stroke element such as the plunger 2, the inertia J of the rotary drive 3, the joint kinematics 4 with their mass and positions and a means such as spring F. This exemplary embodiment of the present invention is based on this model.

The energy transfer is herein shown, for example, by means of a spring F.

The data for the movement of the involved component to be optimized, such as the stroke element designed as a plunger 2, is defined by way of an analysis tool 5.1 of a control and regulation device 5 and provided as data for a target speed for moving the respectively involved component such as the stroke element 2.

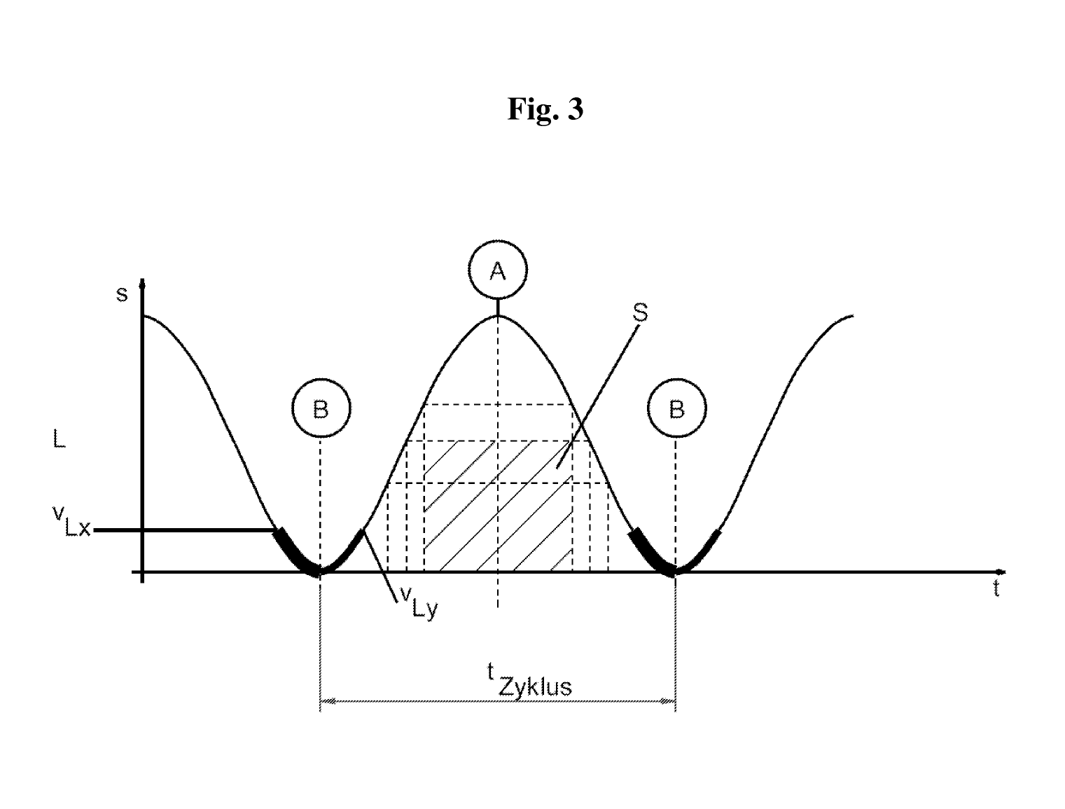

FIG. 3 graphically shows the implementation principle of the method. The symbols or dimensions of the relations according to the present invention are explained as follows:

In the coordinate system of this curve, the time axis is designated t and the distance axis is designated s, namely similarly to FIG. 1, to represent the linear motion sequence of the stroke element 2, such as the plunger. The course of the lines B-A-B with a cycle time t_{Zyklus} represents the linear movement sequence, which is composed of a forming time t_{Lx+Ly}, comprising the partial sections Lx+Ly, and an opened time t_{L-(Lx+Ly)} of the section L minus forming time t_{Lx+Ly} in the movement sequence relevant to the present invention. An impact velocity V_{Lx}, acting before the position B, and a lift-off speed V_{Ly}, acting after the position B, which are an integral part of the forming time t_{Lx+Ly} and are typical of the method of the present invention, are shown in the curve.

From FIG. 3, the person skilled in the art can learn a so-called but not designated opened time t_{L-(Lx+Ly)}. This refers to the time during which there is no contact between the upper tool 2.1 in this case and a non-designated bottom tool shown in FIG. 4, which is still to be explained. As a part of the present invention, said opened time t_{L-(Lx+Ly)} has to take into account a so-called problematic geometry S, such as justified by a work piece 2.2 (FIG. 4) and the joint kinematics 4 (FIG. 2, FIG. 4), which is also functionally important with regard to the freedom of movement required by the object of the present invention.

When implementing the inventive idea, according to which, in a sequence of steps or selection of steps, i.e., a time sequence or offset sequence:
a) the amount of an energy W_{erf} required for machining the work piece 2.2 (here named as such and not shown) is calculated in a first step, taking into account a first value W_{erf 1} (here named as such and not shown) of at least one energy-storing element of the machine tool, such as
   a translatorily or rotationally moved mass m of the drive 3 or
   a liftable/lowerable machine element such as the stroke element 2 or
   a pre-tensionable element, such as a spring or a piston/cylinder unit (here named and not shown) or
   an electrical energy storage device (named here and not shown), such as in an electric network or accumulator (named here and not shown) and calculated and provided as energy W_{erf 1} (here named as such and not shown),
b) that in a second step, the energy W_{erf 1} thus provided is gathered in at least one section L or in a first partial section Lₓ of a motion sequence of the stroke element 2 determined for machining the work piece 2.2, during the cycle time t_{Zyklus} or machining time t_{Lx+Ly} or the opened time t_{L} in the operation of the machine tool, and
c) that in a third step, the energy W_{erf} to be expended for machining the work piece 2.2 is used partially from the energy potential stored and provided in the machine tool according to feature (a) and that, by forming a second value W_{erf 2} (here named as such and not shown) for an effective energy by means of at least one energy-saving element of the machine tool, such as
   the translatorily or rotationally moved mass m of the drive 3, or
   the liftable/lowerable machine element such as the stroke element 2, or
   the pre-tensionable element, such as the spring F or the piston/cylinder unit, or
   the electrical energy store,
the chronological sequence of stroke element 2 or the path of the stroke H is acted upon in an accelerating or decelerating manner,

the energy requirement named here is determined in accordance with the second value W_{erf 2} (here named as such and not shown) as an effective energy for the drive based on the frictional energy, the forming energy and the efficiency losses.

The frictional energy takes into account the path of the stroke height H between OT and UT (FIG. 1) and the joint kinematics 4. The forming energy is determined based on the operations of the tool 2.1 (FIG. 4) acting with the plunger 2 (FIG. 2, FIG. 4). The efficiency losses include losses from dynamic changes, from the drive power and from the natural frequency explained in FIG. 2.

With regard to the features mentioned above, the principle of the method is implemented by modifying:
inertias or moments of inertia J of at least one of the translationally or rotationally moved masses m of drive 3 or of at least one liftable machine element such as the stroke element 2, or
the stored/storable energy from the pre-tensionable element, such as the spring F or piston/cylinder unit, or
the stored/storable electrical energy of the electrical energy storage device by designing an electric motor or electric generator (not shown here),

in order to influence the chronological sequence of the stroke element 2 or the path of the stroke H.

It thus becomes comprehensible that:
a) the direction of motion of the rotary drive 3 executing a full stroke can be changed after each one stroke H via or before the top dead center OT to or via the bottom dead center UT or vice versa,
b) a standstill of the rotary drive 3 can be initiated in the end position A of the linearly moved stroke element 2 in the upper dead center OT in such a manner that said end position A corresponds to the standstill of the rotary drive 3,
c) a reversal of the movement of the linearly moved stroke element 2 can be induced in the end position B in the bottom dead center UT by way, for example, of joint kinematics 4, by partly use of the stored rotational energy the energy, whereby,
d) for an effective energy requirement of the drive 3 for machining the work piece 2.2, this energy W_{erf 2} takes into account at least one energy among the categories comprising a frictional energy, a forming energy, an energy for efficiency losses, an energy for accelerated or decelerated masses m or an energy for balancing a weight of the stroke element 2, i.e., can also be supplemented by at least one of the categories.

On the other hand, it is possible to maintain the direction of the movement of the rotary drive 3 executing a full stroke after each stroke H via or before the top dead center OT to or via the bottom dead center UT or vice versa, a change of the rotary drive 3 being then initiated in the end position A of the linearly moved stroke element 2 in the top dead center OT in such a manner that said end position A matches the standstill of the rotary drive 3.

The procedure is therefore implemented in such a way that the energy W_{erf 2} is determined by taking into account at least one energy among the categories comprising:
a) the frictional energy resulting from a height of the stroke H and from the joint kinematics 4,
b) the forming energy resulting from the operations of the tool 2.1, or
c) the energy comprising the areas of dynamic changes of the drive power or the natural frequency for energy efficiency losses.

The method further provides that:
a) energy transfers are matched in accordance with the sequence of steps or selection of steps from the required energy W_{erf 1} to the formation of the effective energy W_{erf 2} by means of at least one of the energy storing elements of the machine tool 1 or by designing a component or several components of at least one of the energy storing elements, so that at least one movement of the stroke element 2 supporting the respective state in the machining process and influenced by the chronological sequence of the stroke element 2 or the path of the stroke H can be initiated in the machine tool such as the press 1, wherein
b) data from at least one of the conditions:
   of stresses of the tool 2.1,
   for distances to be observed in an operation mode for coordinating motion processes as well as the freedom of motion for work pieces 2.2 to be machined,
   of a high output of the work pieces 2.2 to be machined,
   of an energy consumption, or
   of the chronological sequence of the stroke element 2 or of the path of the stroke H
is recorded,
c) the data then being input or applied either to influence the potential energy of an initial position of an involved component, such as a stroke element or plunger 2, or to change inertias of an involved, energy storing component moved rotationally or translationally, and the velocity curve of the involved component being controlled or regulated by way of the recorded energy states in the machine tool, such as the press 1,
d) so that the performance data of the machine tool 1 such as a press is optimizable with regard to:
   stresses of the tool 2.1,
   distances to be observed in an operation mode for coordinating motion processes as well as the freedom of motion for work pieces 2.2 to be machined,
   the output of the work pieces 2.2 to be machined,
   the energy consumption, or
   the chronological sequence of the stroke element 2 or of the path of the stroke H.

To this end, the data for drive powers for an optimized chronological sequence of the stroke element 2 or path of the stroke H is formed by taking into account at least frictional forces or at least one energy for machining the work piece 2 or both categories, wherein that data of frictional forces or of an energy for machining the work piece 2.2 is determined based either on data from the entire section L or from a partial section Lx of a motion sequence of the stroke element such as a plunger 2.

Data from dynamic changes of the involved component, such as the stroke element or plunger 2, can also be recorded and input or applied for an overlay of the optimized course of the stroke element 2 or of the path of the stroke H.

The joint kinematics 4 such as the joint transmissions are operated depending on the rotational speed of the rotary drive 3, for the energy-optimized movement of the involved component, such as the stroke element or plunger (2) for machining the work piece 2.2, so that an ideal rotational speed of the optimized movement of a machining process and not a constant rotational speed is reproduced.

By using a program for the control and regulation device 5 with at least one of the program steps comprising:
recording, processing, inputting data for:
   the direction of movement of the rotary drive 3,
   the respective end position of the linearly moved stroke element, such as the plunger (2), in the top dead center OT or bottom dead center UT,
   the standstill of the rotary drive 3 in the top dead center OT and correspondence of the end position with the standstill of the rotary drive 3,
   the reversal of the movement of the linearly moved stroke element, such as the plunger 2, in an end position in the bottom dead center UT via the joint kinematics 4 by means of the rotational energy stored in it,
recording, processing, inputting data for
   the occurring energy transfers from the required energy W_{erf 1} to the formation of the effective energy W_{erf 2} for initiating a course of the stroke element 2 or path of the stroke H supporting or optimizing the respective states in the machining process,
   stresses of the tool 2.1,
   for distances to be observed in an operation mode for coordinating motion processes as well as the freedom of motion for work pieces 2.2 to be machined,
   a high output of the work pieces 2.2 to be machined,
recording, processing, inputting data to influence the potential energy of an initial position of an involved component (stroke element such as a plunger 2) or to change the inertias J of the energy storing component (stroke element, such as a plunger 2, or rotary elements, such as the drive 3) and the velocity curve of the involved component by way of the recorded energy states in the machine tool such as the press 1,
recording, processing, inputting/applying data for drive powers for the optimized course of the stroke element 2 or the path of the stroke H, taking into account frictional forces and an energy such as a forming energy for machining such as forming the parts such as work pieces 2.2, which is determined based on data of a whole section L or a partial section Lx of a motion sequence of the involved component (stroke element such as plunger 2),
recording, processing, inputting data from dynamic changes of the involved component (stroke element such as the plunger 2 or rotary elements such as the drive 3) for an overlay of the optimized course of the stroke element 2 or of the path of the stroke H,
recording, processing, inputting data for the joint kinematics 4 (joint transmissions) to be controlled as a function of a rotational speed of the rotary drive 3 for an optimized course of the stroke element 2 or path of the stroke H, or
recording, processing, inputting data for the optimized course of the stroke element 2 or for the path of the stroke H by way of the analysis tool 5.1 of the control and regulation device 5 and presetting that data for the operation of the machine tool such as a press 1,

the press 1 can be operated in an optimized and advantageously automated manner, in accordance with the inventive idea.

FIG. 4 explains the functional diagram of a device for implementing the procedure, according to which the press 1 can be constructionally implemented.

In addition to the already mentioned customary components of the press 1, namely a stroke element 2 such as plunger, a tool 2.1, a rotary drive 3 and joint kinematics 4, a newly designed control and regulation device 5 with the analysis tool 5.1 is provided, which defines data for the movement of the stroke element such as the plunger 2 to be energertically optimized by way of the control and regulation device 5 and provides that data for a target speed for moving the stroke element such as the plunger for operating the press 1.

Other provided components are:
The linearly movable stroke element such as the plunger 2 as a first energy source, which:
   is connected to the translational or, in this case, rotary drive 3 as a second energy source, and
   is operatable in strokes H via or before the top dead center OT to or via a bottom dead center UT, wherein the direction of movement of the rotary drive 3 is changeable or maintainable after each stroke H and a standstill of the rotary drive 3 occurs in the end position of the linearly movable stroke element such as the plunger 2 in the top dead center OT, said end position matching the standstill of the rotary drive 3 and a reversal of the movement of the linearly movable stroke element, such as the plunger (2), being inducible in the end position in the bottom dead center UT by way of the joint kinematics 4 by means of the energy stored in the second energy source 3.
The control and regulation device 5 for the inducible optimized course of the stroke element 2 or path of the stroke H of the machine tool such as the press 1, supporting the respective state in the machining process, by means of which, according to the method,
   data from at least one of the conditions:
      of stresses of the tool 2.1,
      for distances to be observed in an operation mode for coordinating motion processes (freedom of motion) for work pieces 2.2 to be machined, or
      of a high output of the work pieces 2.2 to be machined,
is first recordable,
   data then being adapted to be input either to influence the potential energy of an initial position of an involved component of the first energy source (stroke element such as the plunger 2) or to change inertias or moments of inertia J of the involved component, of a rotary element such as the motor of the drive 3 or of the spring element F, and the velocity curve of the involved component (stroke element such as the plunger 2) being adjustable by way of the recorded energy states in the machine tool, such as the press 1,
   so that the performance data of the machine tool such as the press 1 is optimizable with regard to:
      stresses of the tool 2.1,
      distances to be observed in an operation mode for coordinating motion processes (freedom of motion) for the work pieces 2.2 to be machined,
      an output of the work pieces 2.2 to be machined, or
      to the energy consumption.
The drive 3, comprising at least (not shown) a motor, an eccentric gear, the rotary drive such as a pinion gear or the translational drive such as the linear drive, the joint kinematics 4, comprising at least (not shown) connecting rods, guide elements, traction/pressure elements or tie rods, energy storing means, such as at least the first energy source, comprising the stroke element 2, a stroke element/plunger weight compensation device (not shown), and the second energy source, comprising the translational (not shown) or rotary drive 3 with the flywheel (not shown),
   means 5.2 of the control and regulation device 5 for recording, processing or outputting a respective amount,
   of the energy W_{erf} required for machining the work piece 2.2,
   of the first value W_{erf 1} of at least one energy storing element of the machine tool 1 as an available energy W_{erf 1} in at least one section L or first partial section Lx of a motion sequence of the stroke element 2 defined for machining the work piece 2.2, and
of the second value W_{erf 2} as an effective energy in the cycle time t_{Zyklus} or processing time t_{Lx+Ly} or in the opened time t_{L-(Lx+Ly)} in the operation of the machine tool.
At least one energy-storing element (not shown), the inertia or moment of inertia J of which is changeable, which can be configured as:
   a flywheel or flywheel with a variable effective diameter, or
   as a hollow body in the flywheel, said hollow body being adapted to be filled with or emptied of liquid media or bulk materials, or
   as a flyweight influenced by the rotational speed, or
   as a body that is loadable by the stroke element such as the plunger and modifiable inversely to a speed of the stroke element 2 such as the plunger
for changeable inertias or moments of inertia J.
The device with the changeable inertias or moments of inertia J of the named components, which are cyclically controllable/adjustable or pre-settable depending on the tool at each stroke of the press.

According to the goal set by the object to constantly supply, in a generic machine tool, during the cycle time, the minimal energy requirement by minimizing it and to adjust the natural frequency of the machine to the target motion in order to minimize the demand for additional drive power, the proposed method and device show the way for an energy-optimized machine tool, which opens up economic advantageous for users. Such a machine is constructionally and technologically manufacturable at low cost with customary machine and control elements.

The present invention is not limited to embodiments described herein; reference should be had to the appended claims

### LIST OF REFERENCE SIGNS

A start and end of the movement
B end of the forming movement
F pre-tensionable element, such as a spring, symbol for the energy transfer
J inertia, moment of inertia
H stroke
OT top dead center.
UT bottom dead center.
L section of a motion sequence
Lx first partial section of a motion sequence
Ly second partial section of a motion sequence
Lx+Ly forming time
m mass of the stroke element 2 such as a plunger
S problematic geometry
s distance axis of the linear movement pattern
t time axis of the linear movement pattern
W_{erf} energy required (not graphically presentable) for machining a work piece 2.2
W_{erf 1} first value of an energy-storing element of the machine tool as an available energy (not graphically presentable) in at least one section L or first partial section Lx of a motion sequence of the stroke element 2 defined for machining the work piece 2.2
W_{erf 2} second value (not graphically presentable) as an effective energy in a cycle time t_{Zyklus}, forming time t_{Lx+Ly} or in an opened time t_{L-(Lx+Ly)} during the operation of the machine tool
α axis of a speed for a rotary motion pattern
ω axis of a speed for a rotary motion pattern
t_{Zyklus} cycle time=f (forming time (Lx+Ly)+opened time (L-forming time))
t_{Lx+Ly} forming time
t_{L-(Lx+Ly)} opened time
V speed
V_{Lx} impact speed
V_{Ly} lift-off speed
1 machine tool such as a press
2 stroke element such as a plunger
2.1 tool
2.2 work piece to be machined
3 rotary drive
4 joint kinematics
5 control and regulation device
5.1 analysis tool
5.2 means of the control and regulation device 5 for recording, processing or outputting amounts, such as the required energy W_{erf}, of the first value W_{erf 1} of at least one energy-storing element of the machine tool as available energy in at least the section L or in the first partial section Lx of the motion sequence of the stroke element 2 determined for processing the work piece 2.2 and of the second value W_{erf 2} as an effective energy in the cycle time t_{Zyklus}, forming time t_{Lx+Ly} or opened time t_{L-(Lx+Ly)} during the operation of the machine tool 1.

What is claimed is:

1. A method for operating a machine tool, the machine tool comprising:
a stroke element configured to be linearly moveable; and
a drive configured to drive the stroke element,
wherein, the stroke element is configured to be operated with at least one stroke via or before a top dead center to or via a bottom dead center for machining a work piece, the method comprising steps for a targeted energy transfer comprising:
a) determining and providing/storing an energy for machining the work piece as an available energy (W_{erf 1}) by taking into account a first value of the energy to be applied of at least one element of the machine tool configured to store energy selected from:
a translationally or rotationally moved mass of the drive,
a liftable/lowerable machine element,
a pre-tensionable element, and
an electrical energy storage device,
b) gathering the available energy (W_{erf 1}) provided in at least one section or in a first partial section of a motion sequence of the stroke element determined for machining the work piece in a cycle time, in a machining time, or in an opened time in the operation of the machine tool, and
c) using at least a part of the available energy (W_{erf}) of the energy (W_{erf}) to be applied for machining the work piece from an energy potential provided/stored in the machine tool in step a), and, forming a second value for an effective required energy (W_{erf 2}) via at least one energy-storing element selected from:
the translationally or rotationally moved mass of the drive,
the liftable/lowerable machine element,
the pre-tensionable element, and
the electrical energy storage device,
wherein,
a control and a regulation of different energy transfers or different energy contents of individual drive components is influenced in an accelerating or in a decelerating manner during a chronological sequence of the stroke element or during a path of the at least one stroke so as to compensate for asymmetric loads resulting from an asymmetric force distribution in the machining.

2. The method as recited in claim 1, wherein at least one of:
the machine tool is a press,
the stroke element is a plunger of a press,
the liftable/lowerable machine element is the stroke element,
the pre-tensionable element is a spring or a piston/cylinder unit,
the electrical energy storage device is an electric network or an accumulator,
the drive is a translational drive or a rotary drive, and
the machining is a forming process.

3. The method as recited in claim 2, wherein, to influence the chronological sequence of the stroke element or the path of the at least one stroke, the method further comprises:
modifying an inertia or a moment of inertia of at least one of the translationally or rotationally moved mass or of the at least one liftable/lowerable machine element.

4. The method as recited in claim 3, wherein the at least one liftable/lowerable machine element is the stroke element.

5. The method as recited in claim 4, wherein, to influence the chronological sequence of the stroke element or the path of the at least one stroke, the method further comprises:
modifying a stored/storable energy from the pre-tensionable element.

6. The method as recited in claim 5, wherein,
the machine tool further comprises at least one of an electric motor or an electric generator,
wherein, to influence the chronological sequence of the stroke element or the path of the at least one stroke, the method further comprises:
modifying the stored/storable electrical energy of an electrical energy store by changing a dimensioning of the electric motor or of the electric generator.

7. The method as recited in claim 5, wherein the method further comprises:
a) changing a direction of motion of the drive when executing a full stroke after each of the at least one stroke via or before the top dead center to or via the bottom dead center or vice versa,
b) initiating a standstill of the drive in a first end position of the stroke element in the upper dead center so that the first end position corresponds to the standstill of the drive,
c) initiating a reversal of a movement of the stroke element in a second end position in the bottom dead center via a joint kinematics by partly introducing a stored rotational energy of the effective required energy (W_{erf 2}),
wherein,
the effective required energy (W_{erf 2}) for the drive to machine the work piece takes into account/is supplemented by at least one of a frictional energy, a forming energy, an energy for efficiency losses, an energy for accelerated or decelerated masses, and an energy for compensating for a weight of the stroke element.

8. The method as recited in claim 5, wherein the method further comprises:
a) maintaining a direction of motion of the drive when executing a full stroke after each of the at least one stroke via or before the top dead center to or via the bottom dead center or vice versa,
b) initiating a modification of the drive in a first end position of the stroke element in the upper dead center so that the first end position corresponds to a standstill of the drive,
c) initiating a reversal of a movement of the stroke element in a second end position in the bottom dead center via a joint kinematics by partly introducing a stored rotational energy of the effective required energy (W_{erf 2}),
wherein,
the effective required energy (W_{erf 2}) for the drive to machine the work piece takes into account/is supplemented by at least one of a frictional energy, a forming energy, an energy for efficiency losses, an energy for accelerated or decelerated masses, and an energy for compensating for a weight of the stroke element.

9. The method as recited in claim 5, wherein the method further comprises:
a) determining the effective required energy (W_{erf 2}) by taking into account at least one of a natural frequency of the machine tool, an inertia of the drive, a mass of the stroke element, and a joint kinematics,
inducing a targeted energy transfer by at least one device, and
b) defining a motion sequence by taking into account the natural frequency of the machine tool according to at least one of an impact velocity, a lift-off speed or a problematic geometry.

10. The method as recited in claim 9, wherein at least one of:
the motion sequence is the chronological sequence of the stroke element or the path of the at least one stroke, and
the at least one device is the spring.

11. The method as recited in claim 10, wherein, the machine tool further comprises a tool, and wherein the effective energy (W_{erf 2}) is determined by taking into account at least one of:
a frictional energy resulting from a height of the at least one stroke and from the joint kinematics,
a forming energy resulting from an operation of the tool, and
an energy comprising sections of dynamic changes of a drive power or a natural frequency for energy efficiency losses.

12. The method as recited in claim 11, wherein:
matching an energy transfer from a positional energy of the stroke element to a divided kinetic energy of the stroke element and a rotational energy of the at last one drive within a closed system of the machine tool to each another in accordance with a sequence of steps or a selection of steps from the available energy (W_{erf 1}) to be applied to the formation of the required effective energy (W_{erf 2}) via at least one energy storing element of the machine tool or by providing at least one component of at least one of the energy storing elements so that at least one movement of the stroke element supporting respective states in the machining process of the work piece and influencing the chronological sequence of the stroke element or the path of the at least one stroke is initiated in the machine tool;
recording data from at least one of:
stresses of the tool,
distances to be observed in an operation mode for coordinating motion processes and a freedom of motion for work pieces to be machined,
an output of the work pieces to be machined,
an energy consumption, and
the chronological sequence of the stroke element or of the path of the at least one stroke; and
inputting or applying the data to influence either a potential energy of an initial position of an involved component or to change an inertia of an involved, energy storing component moved rotationally or translationally, a velocity curve of the involved, energy-storing component being controlled or regulated via recorded energy states in the machine tool so that performance data of the machine tool is optimizable with regard to:
stresses of the tool,
distances to be observed in the operation mode for coordinating motion processes and the freedom of motion for work pieces to be machined,
the output of the work pieces to be machined,
the energy consumption, and
the chronological sequence of the stroke element or of the path of the at least one stroke.

13. The method as recited in claim 9, wherein data for drive powers is formed for an optimized chronological sequence of the stroke element or of the path of the at least one stroke by taking into account at least one of frictional forces and at least one energy for machining the work piece,
wherein, frictional forces data or energy for machining the work piece data is determined based either on data from the at least one section or from the first partial section of the motion sequence of the involved component

14. The method as recited in claim 13, wherein data from dynamic changes of the involved component is recorded and input or applied for an overlay of the optimized course of the stroke element or of the path of the at least one stroke.

15. The method as recited in claim 14, wherein the joint kinematics is operated depending on a rotational speed of the drive for an energy-optimized movement of the involved component for machining the work piece so as to reproduce an ideal rotational speed of the optimized movement of a machining process, and not a constant rotational speed.

16. The method as recited in claim 15, wherein the machine tool further comprises a control and regulation device comprising an analysis tool, wherein data for the movement of the involved component to be optimized is defined by the analysis tool and is provided as data for a target speed for moving the respectively involved component so as to operate the machine tool.

17. The method as recited in claim 17, wherein the involved component is the stroke element or the plunger.

18. The method as recited in claim 17, wherein the method further comprises at least one of:
using a program for the control and regulation device with at least one of the program steps comprising a recording, a processing and an inputting of data for:
a direction of movement of the drive,
a respective end position of the stroke element in the top dead center or in the bottom dead center,
a standstill of the drive in the top dead center and a correspondence of the end position with the standstill of the drive,
a reversal of a movement of the stroke element in the end position in the bottom dead center via the joint kinematics via a rotational energy stored therein,
recording, processing, inputting data for:
an occurring energy transfer from the available energy (W_{erf 1}) to a formation of the effective required energy (W_{erf 2}) for initiating a course of the stroke element or a path of the at least one stroke supporting or optimizing the respective states in the machining process,
stresses of the tool,
distances to be observed for an operation mode for a coordinating motion processes (freedom of motion) for the work pieces to be machined, and
of an output of the work pieces to be machined;
recording, processing, and inputting data to influence a potential energy of an initial position of the involved component or to change the inertia of the energy storing component and a velocity curve of the involved component via the recorded energy states in the machine tool;
recording, processing, inputting/applying the data for drive powers for the optimized course of the stroke element or the path of the at least one stroke, taking into account the frictional forces and the energy for machining of the parts determined based on data of the at least one section or of the first partial section of the motion sequence of the involved component;
recording, processing, and inputting data from dynamic changes of the involved component or from rotary elements for an overlay of an optimized course of the stroke element or of the path of the at least one stroke;
recording, processing, and inputting data for the joint kinematics to be controlled as a function of a rotational speed of the drive for an optimized course of the stroke element or the path of the at least one stroke; or
recording, processing, and inputting data for an optimized course of the stroke element or for the path of the at least one stroke via the analysis tool of the control and regulation device, and presetting the data for the operation of the machine tool.

19. A device for implementing the method as recited in claim 1 for a machine tool, the machine tool comprising:
at least one stroke element configured to be linearly moveable as a first energy source; and
a drive as a second energy source connected to the at least one stroke element;
wherein,
the at least one stroke element is configured to operate in strokes via or before a top dead center to or via a bottom dead center,
a direction of motion of the drive after each of the strokes via or before the top dead center to or via the bottom dead center, or vice versa, is changeable or maintainable,
the drive stands still in an end position of the at least one stroke element in the top dead center, the end position corresponding to a standstill of the drive, and
a reversal of a movement of the at least one stroke element is inducible in the end position in the bottom dead center by way of a joint kinematics via an energy stored in the second energy source.

20. The device as recited in claim 19, wherein at least one of:
the machine tool is a press,
the at least one stroke element is a plunger, and
the drive is a rotary drive or a translational drive.

21. The device as recited in claim 20, wherein,
the device comprises a control and regulation device configured to initiate an optimized course of the at least one stroke element or a path of the stroke and to support respective conditions in the machining process via;
data from at least one of the conditions:
stresses of a tool,
distances to be observed in an operation mode for coordinating motion processes and a freedom of motion for work pieces to be machined, or an output of the work pieces to be machined,
is recordable,
the data is then adapted to be input either to influence a potential energy of an initial position of an involved component of the first energy source or to change an inertia or a moment of inertia of the involved component, of a rotary element, or of a spring element, and a velocity curve of the involved component is adjustable by way of recorded energy states in the machine tool so that performance data of the machine tool is optimizable with regard to:
stresses of the tool,
distances to be observed in the operation mode for coordinating motion processes and the freedom of motion for work pieces to be machined, or
the output of the work pieces to be machined, or
an energy consumption.

22. The device as recited in claim 21, wherein at least one of:
the rotary element is a motor of the drive, and
the involved component is the stroke element.

23. The device as recited in claim 22, wherein:
the drive comprises at least one of a motor, an eccentric gear, a rotary drive and a translational drive,
the joint kinematic comprises at least one of connecting rods, guide elements, traction/pressure elements, and tie rods, and
an energy storage device comprises at least one of:
a first energy source comprising at least one of the stroke element and a stroke element/plunger weight compensation device,
a second energy source comprising the drive and a flywheel,
a recording, processing or outputting a device of the control and regulation device configured to record, process or output a respective amount of:
an energy (W_{erf}) required to machine the work piece,
a first value (W_{erf 1}) of at least one energy storing element of the machine tool as an available energy (W_{erf 1}) in at least one section or a first partial section (Lx) of a motion sequence of the stroke element defined for machining the work piece, and
a second value (W_{erf 2}) as an effective energy in a cycle time, in a processing time, or in an opened time in the operation of the machine tool.

24. The device as recited in claim 23, wherein at least one of:
the rotary drive is a pinion gear, and
the translational drive is a linear drive.

25. The device as recited in claim 24, wherein the at least one energy storing element has an inertia or a moment of inertia which is changeable.

26. The device as recited in claim 25, wherein the flywheel or a flywheel with a modifiable effective diameter is configured to modify the inertia or the moment of inertia.

27. The device as recited in claim 26, wherein the flywheel is configured as a hollow body adapted to be filled with or emptied of a liquid media or with bulk materials so as to modify the inertia or the moment of inertia.

28. The device as recited in claim 24, wherein at least one flyweight is configured to be influenced by a rotational speed to modify the inertia or the moment of inertia.

29. The device as recited in claim 24, wherein a body is configured to be loadable via the at least one stroke element and to be modifiable inversely to a speed of the at least one stroke element to modify the inertia or the moment of inertia.

30. The device as recited in claim 29, wherein a tool is configured to cyclically control/adjust per stroke or to preset the modified inertia or the modified moment of inertia of the components.
